(19) United States
(12) Patent Application Publication
(10) Pub. No.: US 2024/0153654 A1
(43) Pub. Date: May 9, 2024

(54) NUCLEAR REACTOR AND FUEL

(71) Applicant: Oklo Inc., Santa Clara, CA (US)

(72) Inventor: Jacob DeWitte, Mountain View, CA (US)

(21) Appl. No.: 18/550,166

(22) PCT Filed: Mar. 14, 2022
(86) PCT No.: PCT/US2022/020253

§ 371 Date: Sep. 12, 2023

Related U.S. Application Data
(60) Provisional application No. 63/160,480, filed on Mar. 12, 2021.

(51) Int. Cl. G21C 3/60; G21C 3/04; G21C 7/14; G21C 7/24; G21C 7/28

(52) U.S. Cl. CPC G21C 3/60; G21C 3/042; G21C 7/14; G21C 7/24; G21C 7/28

(57) ABSTRACT

A commercial nuclear fuel system includes: a vessel that defines an inner volume; a reactor core positioned within the inner volume; and a plurality of fuel pins disposed in the reactor core, each of the plurality of fuel pins comprising at least one hydride fuel element positioned in a cladding. The at least one hydride fuel element is enriched to twenty percent or less of fissile material. The fissile material comprises one or more of uranium-233, uranium-235, or plutonium-239. The fuel pins are positioned in a lattice within the reactor core. The vessel comprises a first vessel, and a second vessel is positioned within the first vessel and surrounds the plurality of fuel pins. At least one reflector is positioned within the first vessel and surrounds the plurality of fuel pins. A shielding assembly is positioned between the reflector and the first vessel.

### TECHNICAL FIELD

The present disclosure relates generally to commercial power nuclear reactors, and more specifically to nuclear fuel forms for commercial power nuclear reactors.

### BACKGROUND

Global energy growth and a drive to reduce pollution and emissions is stimulating new activity around the commercialization and design of new reactor technologies. Some of these technologies include small reactors. Some of these reactors incorporate hydride fuels into their design due to the favorable neutronic characteristics of hydride fuels, particularly with respect to their ability to achieve small core designs.

### SUMMARY

Techniques for fabrication and use of nuclear fission reactors using metal hydride fuels are disclosed. The disclosed techniques can yield a small reactor core, including a reactor core that operates using fuel enriched to, e.g., below five percent uranium-235. An example fuel element includes a cylindrical fuel pin made of uranium and zirconium hydride that is contained within a sealed steel tube that is thermally bonded by a liquid metal between the fuel and tube, also referred to as cladding. This forms a fuel pin system, of which many can be arranged to form a nuclear reactor core.

According to some implementations, a commercial nuclear fuel system includes: a vessel that defines an inner volume; a reactor core positioned within the inner volume; and a plurality of fuel pins disposed in the reactor core, each of the plurality of fuel pins including at least one hydride fuel element positioned in a cladding. At least one hydride fuel element is enriched to twenty percent or less of fissile material.

According to some implementations, a nuclear reactor can include: fuel that contains a fissile material such as uranium-233, uranium-235, or plutonium-239 in the form of a hydride fuel; a thermal bond between fuel and cladding; a cladding; a coolant that uses liquid metals, water, gas, or supercritical fluid to transport heat away from the fuel, a heat exchanger to transfer the heat from the coolant or cooling device to a power conversion system, as well as instrumentation, supporting structures and shielding.

According to some implementations the fissile material is in metallic form and mixed with metal hydrides, such as zirconium hydride, yttrium hydride, titanium hydride, scandium hydride, or thorium hydride.

According to some implementations, the uranium metal is mixed to a weight loading fraction ranging from below 8.5 percent to over forty-five percent.

In some examples, the fissile material is uranium enriched to twenty percent or less (e.g., fifteen percent or less, ten percent or less, five percent or less). In some examples, the uranium metal is mixed to a weight loading fraction ranging from twenty-five percent to forty-five percent.

According to some implementations, burnable absorbers, such as erbium are added to the fuel.

According to some implementations, the fuel pins can contain a gas plenum, a hydrogen barrier, and axial reflectors which can be made of uranium, thorium, graphite, or beryllium.

According to some implementations, the fuel pins are arranged in a hexagonal lattice pattern to form the reactor core, and spacer grids, fins, or wire wraps can be used to preserve spacing between fuel pins.

According to some implementations, the fuel pins are arranged in a square lattice pattern to form the reactor core, and spacer grids or fins can be used to preserve spacing between fuel pins.

According to some implementations, the fuel pins can be bundled together to form assemblies or bundles of fuel pins. The assemblies can be in the form of triangles, quadrangles, hexagons, or squares, among others. The fuel bundles can also be surrounded by ducts, which can be closed or perforated to allow for cross flow.

According to some implementations, the fuel pins are held in place by a lower grid plate, which can also act as a flow distributor.

According to some implementations, the reactor core can be surrounded by a neutron reflector, flow baffles or guides, shielding, and a vessel, in various orders of arrangement.

According to some implementations, the reflector can be composed of graphite or beryllium, among others.

In some examples, the reactor core is made of fuel pins enriched to 4.95 percent uranium-235 in a hexagonal pattern, held in place by a lower grid plate, separated by wire wraps, surrounded by a rounded hexagonal vessel, surrounded by a graphite reflector, surrounded by shielding, and contained in an outer vessel.

According to some implementations, gas, such as helium, nitrogen or carbon dioxide transfers heat from the fuel, and carries the heat to a heat exchanger where the heat is transferred to an intermediate coolant or the power conversion working fluid, or carries the heat directly to a turbine-generator system.

According to some implementations, liquid metal, such as sodium, lead, or sodium-potassium alloy transfers heat from the fuel, and carries the heat to a heat exchanger where the heat is transferred to an intermediate coolant or the power conversion working fluid.

According to some implementations, liquid salt, such as a lithium fluoride beryllium fluoride eutectic transfers heat from the fuel, and carries the heat to a heat exchanger where the heat is transferred to an intermediate coolant or the power conversion working fluid.

According to some implementations, water transfers heat from the fuel, and carries the heat to a heat exchanger where the heat is transferred to an intermediate coolant or the power conversion working fluid, or carries the heat directly to a turbine-generator system.

According to some implementations, supercritical fluids, such as water or carbon dioxide transfer heat from the fuel, and carry the heat directly to a turbine-generator system.

In some examples, the coolant circulates and convectively removes heat produced in the fuel, carries the heat to an intermediate heat exchanger and transfers the heat to an intermediate coolant which in turn carries the heat to a power conversion heat exchanger where the heat is transferred to a power conversion working fluid. In some examples, the intermediate coolant loop can use a salt, a gas, water, or a liquid metal as its coolant. In some examples, the power conversion system can use a gas or a supercritical working fluid, such as steam or carbon dioxide.

According to some implementations, the primary coolant flows by natural circulation, transferring heat by natural convection.

According to some implementations, the intermediate coolant flows by natural circulation, transferring heat by natural convection.

In some examples, the reactor coolant flow loop is configured so that the elevation between the fuel and the heat exchangers in the reactor coolant system are sufficient to achieve adequate buoyancy to drive natural circulation. In some examples, the intermediate coolant flow loop is configured so that the elevations between heat exchangers in the reactor coolant system are sufficient to achieve adequate buoyancy to drive natural circulation.

According to some implementations, the coolant flows by forced circulation driven by a plurality of pumps.

According to some implementations, momentum based circulators such as flywheels are placed after the pump outlet to provide rotating inertia for the coolant.

According to some implementations, pumps are cooled by the coolant, as well as radiation, conduction, and convection to the surrounding environment.

In some examples, electromagnetic pumps are used to pump liquid metals.

According to some implementations, maintaining sufficient coolant chemistry and purity control is important to ensuring coolant and component longevity, and is achieved by filters, cold traps, or cold fingers.

According to some implementations, afterheat, or decay heat, is removed via an auxiliary cooling system.

According to some implementations, afterheat is removed directly from the reactor vessel and coolant loop by conduction, radiation, and convection to the surrounding environment.

According to some implementations, afterheat is removed via dedicated or multipurpose heat exchangers by conduction, radiation, and convection to the surrounding environment.

According to some implementations, air ducts carry cool air from the surrounding environments to convectively cool the reactor system.

According to some implementations, the air is driven by circulators such as fans.

According to some implementations, the air flows by natural circulation.

In some examples, the air flows into the reactor compartment via inlets and ducts where the air is guided to flow along the vessels, piping, and heat exchangers to cool them, and then flows out of the compartment via outlets.

According to some implementations, cooling panels and cooling jackets surround the reactor system, and heat from the reactor system is transferred to them via conduction, radiation, and convection. The cooling panels and jackets then transfer the heat to the ambient environment.

According to some implementations, the cooling panels and jackets use coolants such as water; gases like nitrogen or carbon dioxide; liquid metals like sodium-potassium alloys; or fusible metals like sodium which are solid at normal operating conditions, and can absorb heat via their latent heat of fusion before beginning to circulate.

According to some implementations, the flow paths of the coolant system can be heated actively to ensure the coolant stays molten.

According to some implementations, the shielding and structures of the reactor system serve to attenuate radiation, and act as a thermal heat sink.

According to some implementations, rotating control drums can be used on the periphery of the reactor core to control reactivity. Movable reflectors can also be used.

According to some implementations, movable control rods can be used to control reactivity which can be placed in the reactor core or in the periphery of the reactor core.

According to some implementations, neutron absorbing materials such as boron carbide, cadmium, silver, tungsten, or hafnium can be used in control elements. Neutron reflecting materials such as beryllium or graphite can also be used where relevant in control elements.

According to some implementations, the control system motors and hardware can be positioned above the reactor vessel.

According to some implementations, reactor instrumentation can be placed in the reactor core, in the periphery of the reactor core, in the reflector, in the coolant loops, and outside the vessel.

According to some implementations, the instrumentation and associated cabling can be routed through dedicated ports in top of the reactor vessel.

According to some implementations, the reactor system, the intermediate coolant system, and the power conversion system can be compartmentalized and containerized to allow for mass production, and easy transport.

According to some implementations, the system can be containerized in a manner that allows for transportability.

According to some implementations, a hydride fuel element is enriched to less than one of: fifteen percent of fissile material, ten percent of fissile material or five percent of fissile material.

According to some implementations, a hydride fuel element is fabricated by a process in which a powder metal is hydrided and alloyed.

According to some implementations, a hydride fuel element is fabricated by a process in which a metal is alloyed, powdered, and hydrided.

According to some implementations, a hydride fuel element is fabricated by a process in which a solid metal alloy containing fuel is hydrided.

According to some implementations, hydriding occurs in a hydrogen atmosphere or in a hydrogen stream.

According to some implementations, a reflector is movable in a periphery of a reactor core.

According to some implementations, a control rod is movable in a periphery of the reactor core.

According to some implementations, an absorbing material of a control rod includes at least one of B₄C, hafnium, or silver-indium-cadmium.

According to some implementations, a fuel pin is fabricated by a process that includes loading at least one hydride fuel element into the cladding; positioning a metallic bond material in solid form below or on top of the at least one hydride fuel element in the cladding; and sealing the at least one fuel pin.

According to some implementations, the sealing includes welding.

According to some implementations, a metallic bond material is preloaded into the cladding below the at least one hydride fuel element or on top of the at least one hydride fuel element, or both.

According to some implementations, a process to fabricate a fuel pin includes heating the at least one fuel pin to melt the metallic bond material to surround the at least one hydride fuel element; and moving the heated at least one fuel pin to flow the melted metallic bond material to fully surround the at least one hydride fuel element.

According to some implementations, the moving includes at least one of shaking, tapping, or vibrating.

According to some implementations, a metallic bond material includes a compressible thermal bond material.

According to some implementations, a compressible thermal bond material includes porous graphite.

According to some implementations, a cladding includes a low neutron absorbing material.

According to some implementations, a low neutron absorbing material includes at least one of Niobium 1% Zirconium (Nb1Zr), Zirconium Carbide (ZrC), Silicon Carbide (SiC), Zirconium Nitride (ZrN), stainless steel, nickel-based superalloys, or an isotopically enriched metallic compound.

According to some implementations, a hydride fuel element includes an isotopically enriched metal to reduce neutron absorption.

According to some implementations, a reflector includes at least one of a beryllium alloy, a beryllium ceramic, or graphite.

According to some implementations, a commercial nuclear fuel system includes at least one refueling duct or channel for ease of refueling the system.

The fuel pins can include hydride fuels according to the present disclosure can result in one or more of the following advantages. For example, the use of hydride fuels can allow for reduced reactor core sizes, while allowing for the use of fuel enriched to below five percent uranium-235 (e.g., 4.95 percent uranium-235). Low enrichment of fuel simplifies fuel procurement and fabrication, and reduces the costs of fission reactors. In some examples, very small reactors using hydride fuels enriched to less than five percent uranium-235 can be transportable.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of a radial cross-section of an example implementation of a reactor core according to the present disclosure.

FIG. 2 is a schematic illustration of an axial cross-section of the example implementation of the reactor core of FIG. 1 according to the present disclosure.

FIG. 3 is a schematic illustration of a radial cross-section of another example implementation of a reactor core according to the present disclosure.

FIG. 4 is a schematic illustration of a radial cross-section of another example implementation of a reactor core according to the present disclosure.

FIG. 5 is a schematic illustration of a radial cross-section of another example implementation of a reactor core according to the present disclosure.

FIG. 6 is a schematic illustration of a radial cross-section of another example implementation of a reactor core according to the present disclosure.

FIGS. 7A-7B show a radial cross-section and side view, respectively, of a nuclear fuel form according to the present disclosure.

FIG. 8 is a schematic illustration of an example implementation of a nuclear reactor system according to the present disclosure.

FIGS. 9A-9C show schematic illustrations of a top view, a side view, and a three-dimensional perspective view, respectively, of a power generation system with a nuclear reactor system according to the present disclosure.

FIG. 10A-10C show schematic illustrations of example implementations of a cooling apparatus for a nuclear reactor vessel according to the present disclosure.

FIGS. 10D-10F show schematic illustrations of a side view of example implementations of at least a portion of a power generation system with a nuclear reactor system according to the present disclosure.

FIGS. 10G-10H show a three-dimensional side view and a three-dimensional perspective view, respectively, of the nuclear reactor system of FIG. 10F.

FIG. 11 shows a graph of core design performance over life for example implementations of the present disclosure.

Implementations of the present disclosure will now be described in detail with reference to the drawings, which are provided as illustrative examples of the inventive implementations so as to enable those skilled in the art to practice the example implementations. Notably, the figures and examples are not meant to limit the scope of the present disclosure to a single implementation, but other implementations are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the example implementations.

### DETAILED DESCRIPTION

Global energy growth and a drive to reduce pollution and emissions is stimulating new activity around the commercialization and design of new reactor technologies. Some of these technologies include very small commercial power reactors, some of which incorporate hydride fuels into their design due to the favorable neutronic characteristics of hydride fuels, particularly with respect to their ability to achieve small core designs and their ability to use low enriched uranium enriched to under five percent uranium-235. A commercial power reactor is a nuclear reactor that is used for electricity production, heat generation, or propulsion.

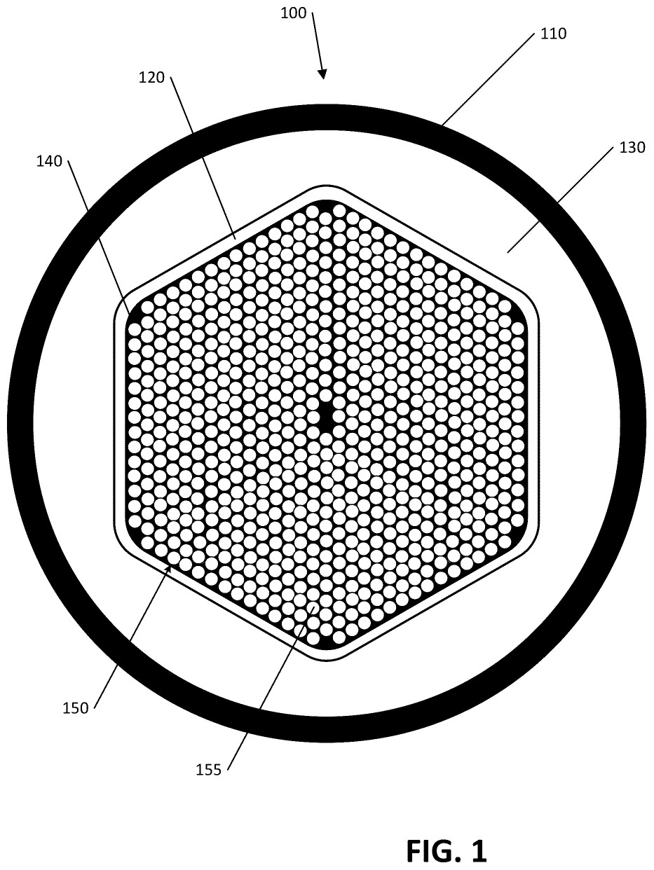

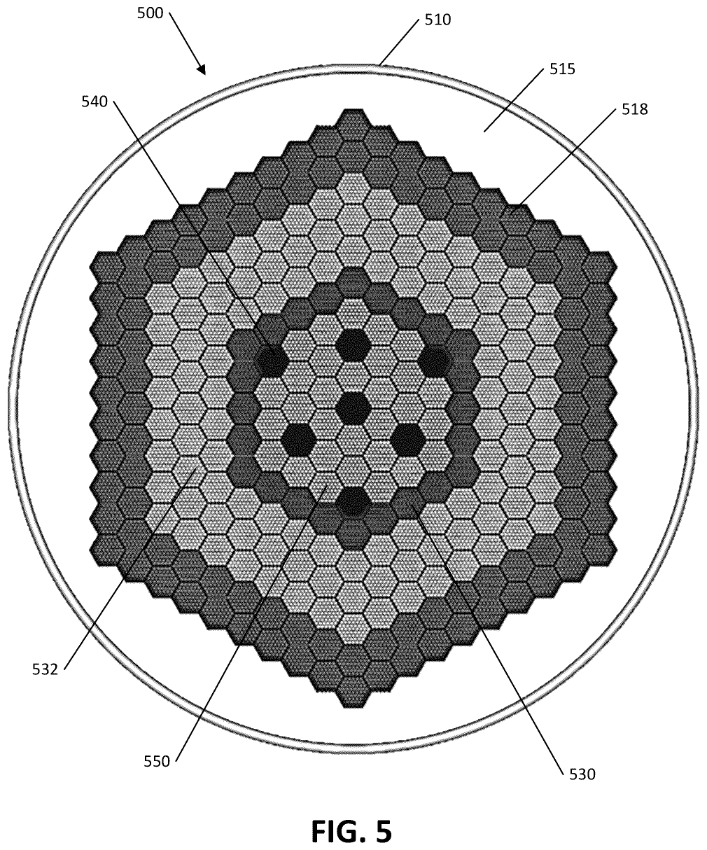

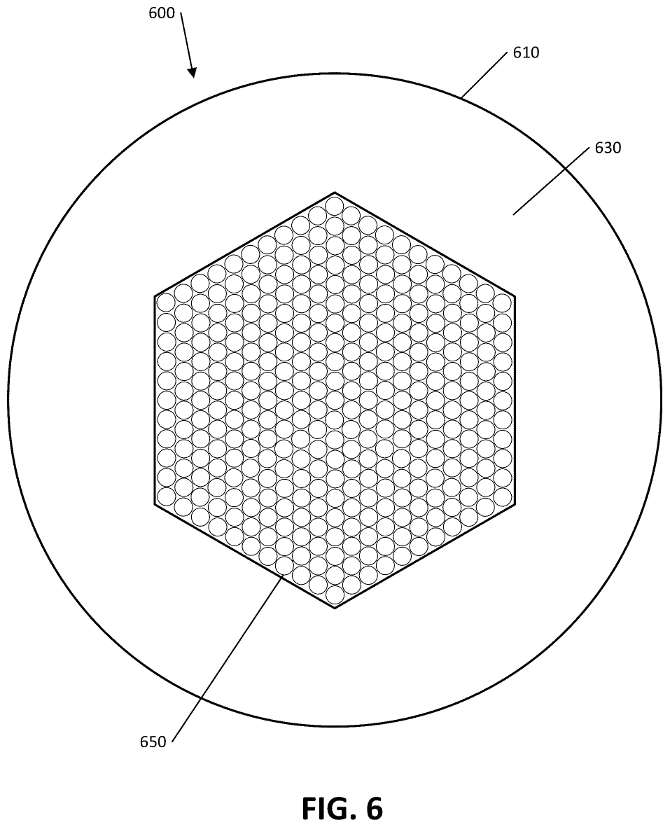

Each of FIGS. 1 and 3-6 show schematic diagrams of a radial cross-sectional of example implementations of a commercial nuclear fuel system according to the present disclosure. Generally, each of the example implementations includes an outer vessel (e.g., steel vessel) that encloses or forms a reactor core of the commercial nuclear fuel system. Each of the example implementations includes a plurality of fuel pins that form a fuel lattice. In some aspects, multiple fuel pins can be positioned to form a fuel lattice (such as a hexagonally shaped fuel lattice, as shown in FIGS. 1, 3, and 6). In some aspects, multiple, hexagonally-shaped fuel lattices can also be arranged within the outer vessel in the shape of a hexagonal fuel lattice (FIG. 5). In some aspects, control locations, such as voids in the fuel lattice (or lattices) that do not include fuel pins and can receive control rods, are formed, such as at edges of the fuel lattice (FIGS. 1, 3, and 4), at a radial center of the fuel lattice (FIGS. 1, 3, 4, and 6), and/or within the fuel lattice itself (FIG. 5). In some aspects, a reflector is positioned between the fuel lattice and the outer vessel (FIGS. 1, 3, 4, and 6). A reflector can be relatively thin (e.g., having a radial thickness of approximately ten centimeters to approximately twenty-five centimeters) (FIGS. 1, 3, and 4) or relatively thick (e.g., having a radial thickness of approximately twenty-five centimeters to approximately fifty centimeters) (FIG. 6). In some aspects, two reflectors (an inner reflector and an outer reflector) can be positioned between the fuel lattice and the outer vessel (FIG. 5). In some aspects, an inner vessel (e.g., steel vessel), such as a hexagonal vessel, is positioned without the outer vessel and adjacent the fuel lattice (FIG. 1). In some aspects, a shielding assembly can be positioned between the fuel lattice and the outer vessel (FIG. 5). In some aspects, a coolant pool (e.g., filled with a cooling fluid) can be formed within the outer vessel (FIG. 5).

FIG. 1 is a schematic illustration of a radial cross-section of an example implementation of a reactor core 100 according to the present disclosure. The reactor core 100 includes an outer reactor vessel 110 and an inner reactor vessel 120. The reactor core 100 also includes a reflector 130 positioned between the outer reactor vessel 110 and the inner reactor vessel 120. The reactor core 100 includes a fuel lattice 150. The fuel lattice 150 includes fuel pins 155. The fuel pins 155 can include hydride fuels. Within the fuel lattice 150 are control positions, e.g., control position 140. Reactor control can be achieved via rotating control drums, movable reflectors, movable control rods, and burnable poisons located in the control positions. Neutron absorbing materials such as boron carbide, cadmium, silver, tungsten, or hafnium can be used in control elements. Neutron reflecting materials such as beryllium or graphite can also be used where relevant in control elements.

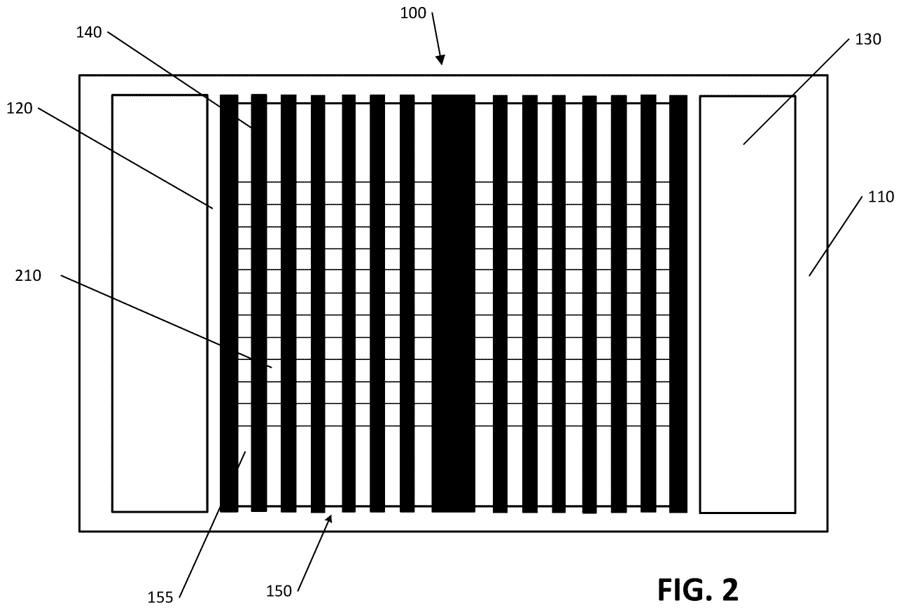

FIG. 2 shows a schematic illustration of an axial cross-section of the example implementation of the reactor core of FIG. 1. Referring to FIG. 2, the reactor core 100 includes an outer reactor vessel 110 and an inner reactor vessel 120. The reactor core 100 also includes a reflector 130 positioned between the outer reactor vessel 110 and the inner reactor vessel 120. The reactor core 100 includes a fuel lattice 150. The fuel lattice 150 includes fuel pins 155. The fuel pins 155 can include hydride fuels. As shown, in some aspects, a fuel pin 155 can include nuclear fuel in the form of one or more fuel elements 210 (or “fuel slugs”). Within the fuel lattice 150 are control positions, e.g., control position 140.

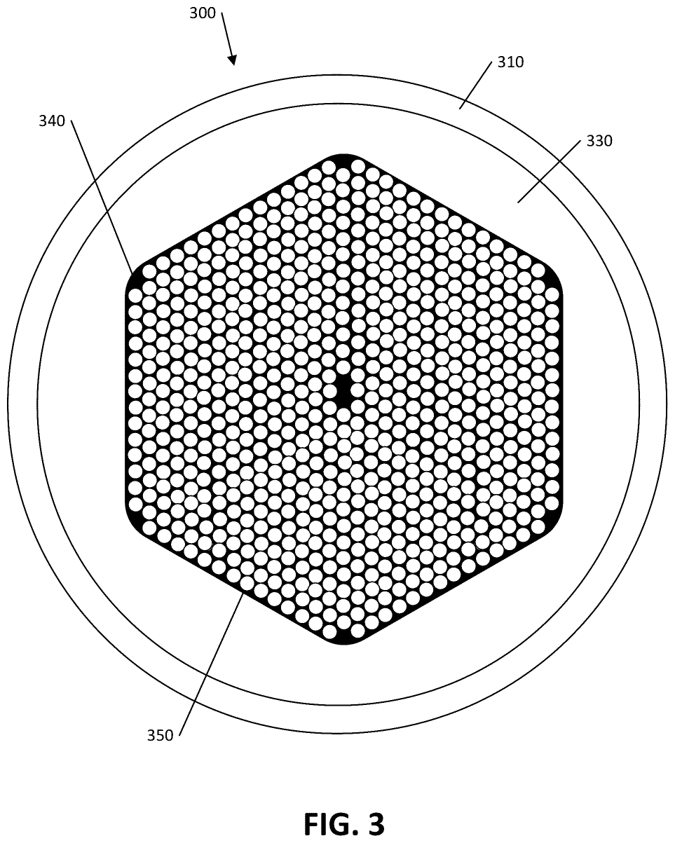

FIG. 3 is a schematic illustration of a radial cross-section of another example implementation of a reactor core 300 according to the present disclosure. The reactor core 300 includes outer reactor vessel 310 and reflector 330. The reactor core 300 includes a fuel lattice 350 and control positions include control position 340. The reflector 330 is adjacent to the fuel lattice 350, surrounds the fuel lattice 350, and is positioned between the outer reactor vessel 310 and the fuel lattice 350.

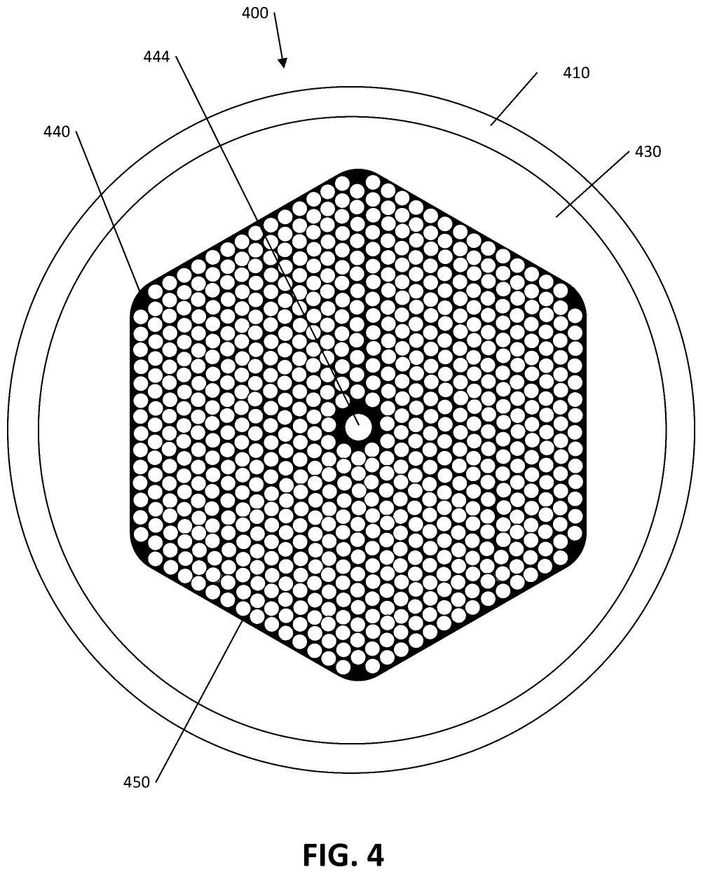

FIG. 4 is a schematic illustration of a radial cross-section of another example implementation of a reactor core 400 according to the present disclosure. The reactor core 400 includes outer reactor vessel 410 and reflector 430. The reactor core 400 includes a fuel lattice 450 and control positions include control position 440 and central control position 444. The reflector 430 is adjacent to the fuel lattice 450, surrounds the fuel lattice 450, and is positioned between the outer reactor vessel 410 and the fuel lattice 450.

FIG. 5 is a schematic illustration of a radial cross-section of another example implementation of a reactor core 500 according to the present disclosure. The reactor core 500 includes an outer reactor vessel 510 and a coolant pool 515. The reactor core 500 includes shielding assemblies 518. The coolant pool 515 is positioned between the shielding assemblies 518 and the outer reactor vessel 510. The reactor core 500 includes a fuel lattice 550 and control positions, e.g., control position 540, within the fuel lattice 550. The reactor core 500 includes an inner reflector 530 and an outer reflector 532. Both the inner reflector 530 and the outer reflector 532 are positioned between the outer reactor vessel 510 and the fuel lattice 550. The shielding assemblies 518 are positioned between the outer reflector 532 and the outer reactor vessel 510.

FIG. 6 is a schematic illustration of a radial cross-section of another example implementation of a reactor core 600 according to the present disclosure. The reactor core 600 includes an outer reactor vessel 610 and a reflector 630. The reactor core 600 includes a fuel lattice 650. The reflector 630 is adjacent to the fuel lattice 650, surrounds the fuel lattice 650, and is between the fuel lattice 650 and the outer reactor vessel 610.

As shown in FIGS. 1-6, the fuel pins of a fuel lattice can be arranged in a hexagonal lattice pattern to form the reactor core, and spacer grids, fins, or wire wraps can be used to preserve spacing between fuel pins. Alternatively, the fuel pins can be arranged in a square lattice pattern to from the reactor core, and spacer grids or fins can be used to preserve spacing between fuel pins. In some examples, the fuel pins can be bundled together to form assemblies or bundles of fuel pins. The assemblies or bundles can be in the form of triangles, quadrangles, hexagons, or squares, among others. The fuel bundles can also be surrounded by ducts, which can be closed or perforated to allow for cross flow. The fuel pins are held in place by a lower grid plate, which can also act as a flow distributor.

The reactor core can be surrounded by a neutron reflector, flow baffles or guides, shielding, and a vessel, in various orders of arrangement. The reflector can be composed of graphite or beryllium, among other suitable reflecting materials. In some examples, the reactor core is made of fuel pins enriched to 4.95 percent uranium-235 in a hexagonal pattern, held in place by a lower grid plate, separated by wire wraps, surrounded by a rounded hexagonal vessel, surrounded by a graphite reflector, surrounded by shielding, and contained in an outer vessel.

In some implementations, the outer reactor vessel (110, 310, 410, 510, 610) has a radius of thirty centimeters (cm) or more (e.g., fifty centimeters or more, sixty centimeters or more, eighty centimeters or more). In some implementations, the outer vessel has a radius of one hundred-forty centimeters or less (e.g., one hundred-twenty centimeters or less, one hundred centimeters or less, ninety centimeters or less).

In some implementations, the reactor core (100, 300, 400, 500, 600) has a radius of twenty-five centimeters or more (e.g., thirty centimeters or more, forty centimeters or more, forty-five centimeters or more). In some implementations, the reactor core has a radius of fifty centimeters or less (e.g., forty-five centimeters or less, forty centimeters or less, thirty centimeters or less).

In some implementations, the reflector (130, 330, 430, 530, 532) has a radial thickness of ten centimeters or more (e.g., fifteen centimeters or more, twenty centimeters or more, thirty centimeters or more). In some implementations, the reflector has a radial thickness of fifty centimeters or less (e.g., forty-five centimeters or less, forty centimeters or less, thirty-five centimeters or less).

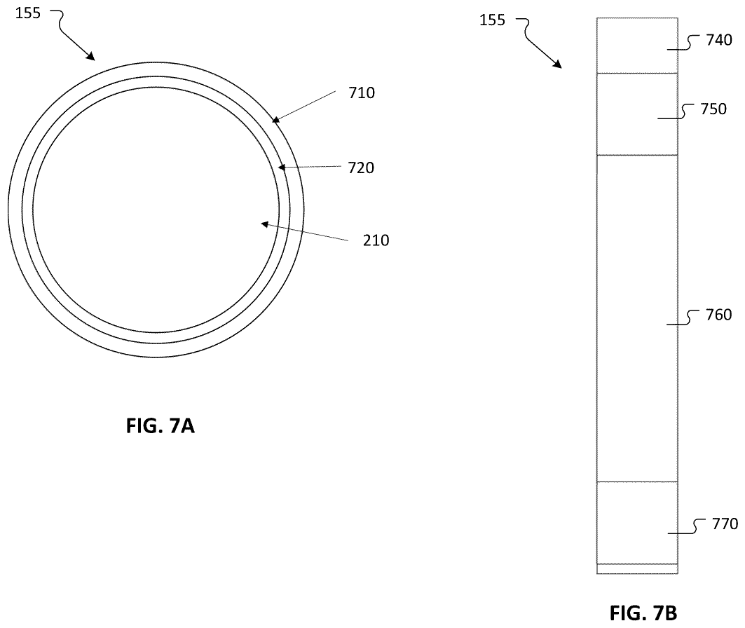

FIGS. 7A-7B show additional schematic illustrations of a fuel pin 155 according to the present disclosure. In some examples, metal hydride fuels can be used to produce a small reactor core, including one that operates using fuel enriched to below twenty percent fissile material (e.g., twenty percent or less, ten percent or less, five percent or less). In some examples, the fissile material is uranium-233, uranium-235, or plutonium-239.

In the example of FIGS. 7A-7B, a cylindrical fuel pin 155 includes fuel elements, e.g., fuel element 210. The fuel element 210 can contain uranium-233, uranium-235, or plutonium-239 in the form of a hydride fuel. The fissile material of the fuel element 210 is in metallic form and mixed with metal hydrides, such as zirconium hydride, yttrium hydride, titanium hydride, scandium hydride, or thorium hydride. The uranium metal can be mixed to a weight loading fraction ranging from below 8.5 percent to over forty-five percent. In some examples, the fissile material is uranium enriched to less than one of: fifteen percent uranium-235, ten percent uranium-235, five percent uranium-235, 4.95 percent uranium-235. Burnable absorbers, such as erbium, can also be added to the fuel.

The fuel element 210 is encased or contained within a sealed steel tube (cladding 710). In some examples, multiple fuel elements 210 can be stacked in a column and surrounded by the cladding 710. In some examples, a bonding layer 720 is formed between the nuclear fuel element 210 and the cladding 710. The bonding layer 720 bonds the cladding 710 to the fuel element 210 and thermally couples the fuel element 210 to the cladding 710. The bonding layer 720 can be displaced as the fuel element 210 expands. The bonding layer 720 can include, for example, a porous graphite material, a gas such as helium or argon, or a liquid metal such as lead or sodium.

In some examples, the cladding 710 has an internal hydrogen barrier. The hydrogen barrier can be formed from materials including a ceramic, e.g., alumina (Al2O3) or Zirconium Dioxide (ZrO2), a metal, e.g., Niobium or Tungsten, and/or a carbide, e.g., Zirconium Carbide.

The cladding 710 can be cooled by a coolant that can use liquid metals, water, or gas to transport heat away from the cladding. The stacked fuel elements 210 surrounded by cladding 710 form a fuel pin 155. Many fuel pins 155 can be arranged to form a nuclear reactor core.

The fuel pins 155 can contain a gas plenum, a hydrogen barrier, and axial reflectors which can be made of uranium, thorium, graphite, or beryllium. As shown in FIG. 7B, a fuel pin 155 can include one or both of an upper reflector 750 positioned above the nuclear fuel and a lower reflector 770 positioned below a nuclear fuel region 760. An upper plenum 740 can be formed above the upper reflector 750, e.g., to form a part of a cooling fluid flow path with plenums of other fuel pins 155 positioned in the fuel lattice (e.g., fuel lattice 150).

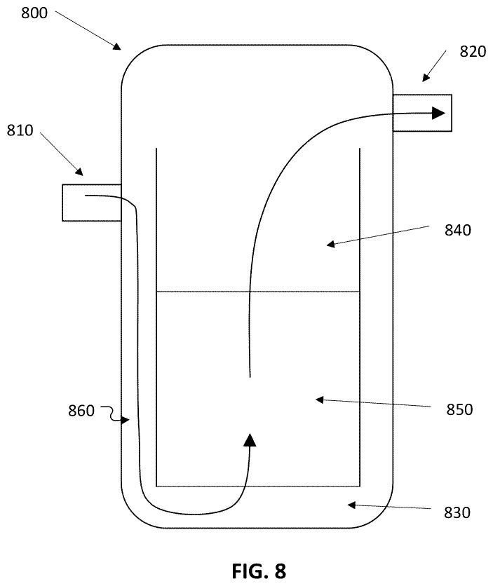

FIG. 8 shows a schematic illustration of an example implementation of a nuclear reactor system that includes, e.g., a commercial nuclear fuel system of one of the example implementations shown in the figures. As shown in FIG. 8, a reactor vessel 800 can include an inner volume into which the reactor core 850 (e.g., including the nuclear fuel system) is placed. The reactor vessel 800 (which can be the outer vessel) in this example includes a coolant inlet 810 into which a coolant (shown by the circuitous arrows 860) can be circulated and a coolant outlet 820 out of which the coolant can be circulated. The circulated coolant can remove at least a portion of heat generated by the nuclear fuel system during operation (e.g., nuclear fission) and transfer such heat to a power generation system for the generation of electrical power. In this example, the coolant can flow from the inlet 810, into a lower plenum 830 below the reactor core 850, through the plenums formed in the fuel pins, into an upper plenum 840 above the reactor core 850, and out of the outlet 820.

In some implementations, the reactor core (100, 300, 400, 500, 600, 850) has a height of fifty centimeters or more (e.g., sixty centimeters or more, seventy centimeters or more, eighty centimeters or more). In some implementations, the reactor core has a height of one hundred centimeters or less (e.g., ninety centimeters or less, eighty centimeters or less, seventy-five centimeters or less).

In some implementations, the reactor core (100, 300, 400, 500, 600, 850) has a fuel mass of four hundred kilograms or more (e.g., four hundred kilograms or more, four hundred-fifty kilograms or more, five hundred kilograms or more). In some implementations, the reactor core has a fuel mass of one thousand kilograms or less (e.g., eight hundred kilograms or less, seven hundred-fifty kilograms, six hundred kilograms or less).

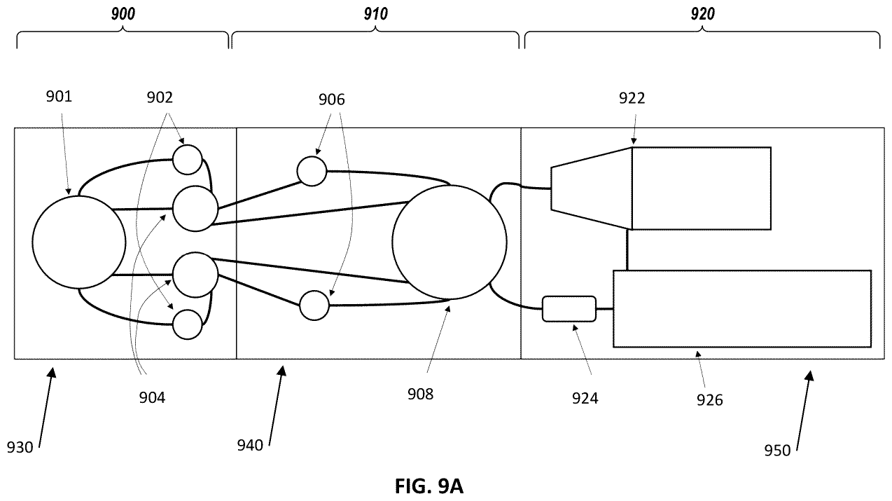

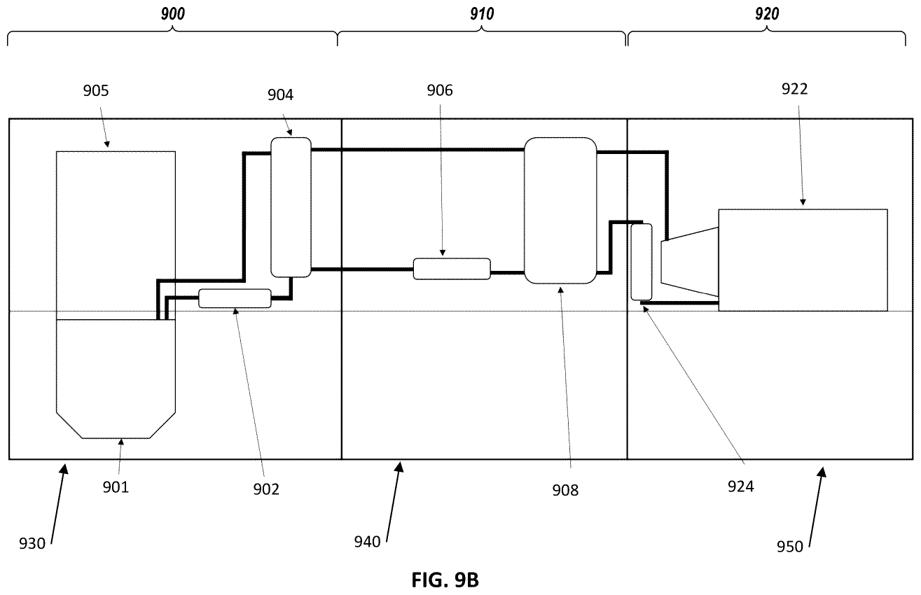

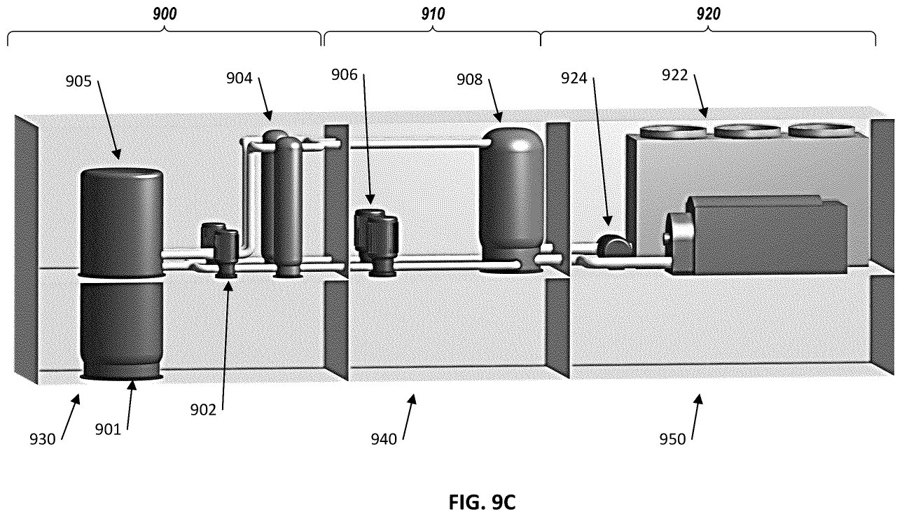

FIGS. 9A-9C show schematic illustrations of a top view, a side view, and a three-dimensional perspective view, respectively, of a power generation system with a nuclear reactor system (e.g., of FIG. 8). As shown, the power generation system includes: (1) a primary thermal sub-system 900 (including a reactor vessel 901, at least one primary pump 902 and at least one intermediate heat exchanger 904); (2) a secondary thermal sub-system 910 (including at least one intermediate pump 906 and at least one power conversion system heat exchanger 908); and (3) a power equipment sub-system 920 (including at least one power generator or power conversion system 922, at least one power conversion system pump 924, and at least one heat rejection radiator 926).

In some implementations, the reactor system, the intermediate coolant system, and the power conversion system can be compartmentalized and containerized to allow for mass production, and easy transport, including transportability. For example, the sub-systems 900, 910, and 920 can be modular such that the sub-system 900 can be assembled separately from the sub-system 910 and from the sub-system 920. The sub-systems 900, 910, and 920 can each have a respective housing 930, 940, 950. The sub-systems 900, 910, and 920 can be transported and installed separately from each other. When in place, the sub-systems 900, 910, and 920 can be connected to form a power generation system.

The primary thermal sub-system 900 is fluidly coupled to the nuclear reactor system through the coolant, which is circulated by the primary pump 902 between the reactor core inside the reactor vessel 901 and the intermediate heat exchanger 904 to transfer heat, via the coolant, from the nuclear fuel system to the intermediate heat exchanger 904. In some examples, the coolant flows by forced circulation driven by a plurality of pumps 902. Momentum based circulators such as flywheels are placed after the pump outlet to provide rotating inertia for the coolant. The pumps 902 can be cooled by the coolant, as well as radiation, conduction, and convection to the surrounding environment. In some examples, electromagnetic pumps are used to pump liquid metals.

In some examples, the reactor vessel 901 includes an upper equipment enclosure 905 for housing additional equipment and components. For example, control system motors and hardware can be positioned above the reactor vessel in the upper equipment enclosure 905. Reactor instrumentation can be placed in the reactor core, in the periphery of the reactor core, in the reflector, in the coolant loops, and/or outside the vessel. The instrumentation and associated cabling can be routed through dedicated ports in top of the reactor vessel.

Gas, such as helium, nitrogen, or carbon dioxide can be used as primary coolant to transfer heat from the fuel. Alternatively, liquid metals, such as sodium, lead, or sodium-potassium alloy can be used as coolant to transfer heat from the fuel. Liquid salts, such as a lithium fluoride beryllium fluoride eutectic, can also be used. Water can also be used, as well as supercritical fluids. Primary coolant can include, for example, sodium, sodium-potassium eutectic alloy, lead, lead-bismuth eutectic alloy, carbon dioxide, supercritical carbon dioxide, water, helium, and nitrogen.

In some examples, the primary coolant flows by natural circulation, transferring heat by natural convection. The reactor coolant flow loop can be configured so that the elevation between the fuel and the heat exchangers 904 in the reactor coolant system are sufficient to achieve adequate buoyancy to drive natural circulation.

In some implementations, the flow paths of the coolant system can need to be heated actively to ensure the coolant stays molten. The shielding and structures of the reactor system can serve to attenuate radiation, and act as a thermal heat sink. Maintaining sufficient coolant chemistry and purity control is important to ensuring coolant and component longevity, and is achieved by filters, cold traps, or cold fingers. Additional chemistry control can be achieved by using exchange beds, such as lead oxide exchange beds to help control oxygen chemistry in liquid lead.

The coolant can carry the heat to a heat exchanger, e.g., to the intermediate heat exchanger 904, where the heat is transferred to an intermediate coolant, or to the power conversion system heat exchanger 908, where the heat is transferred to a power conversion working fluid. In some implementations, the coolant can transfer heat from the fuel directly to a power conversion system 922 such as a turbine-generator system.

The secondary thermal sub-system 910 is fluidly coupled to the primary thermal sub-system 900 through a thermal fluid, which is circulated by the intermediate pump 906 between the intermediate heat exchanger 904 and the power conversion system heat exchanger 908 to transfer heat from the coolant to the thermal fluid. In some examples, the coolant circulates and convectively removes heat produced in the fuel, carries the heat to the intermediate heat exchanger 904, and transfers the heat to an intermediate coolant which in turn carries the heat to the power conversion system heat exchanger 908 where the heat is transferred to a power conversion working fluid.

In some examples, the intermediate coolant loop of the thermal sub-system 910 can use a salt, a gas, water, or a liquid metal as coolant. The intermediate coolant can flow by natural circulation, transferring heat by natural convection. In some examples, the intermediate coolant flow loop is configured so that the elevation between the intermediate heat exchangers 904 and the power conversion system heat exchanger 908 is sufficient to achieve adequate buoyancy to drive natural circulation.

The power equipment sub-system 920 is fluidly coupled to the secondary thermal sub-system 910 through a working fluid, which is circulated by the power conversion system pump 924 between the power conversion system heat exchanger 908 and the power conversion system 922 to transfer heat into the working fluid from the thermal fluid. In some examples, the power conversion system can use a gas or a supercritical working fluid, such as steam or carbon dioxide. The heated working fluid (e.g., high pressure steam) can drive the power conversion system 922 to produce electricity. Working fluid used by the power conversion system 922 (e.g., low pressure steam) can be cooled (e.g., condensed) by the heat rejection radiator 926.

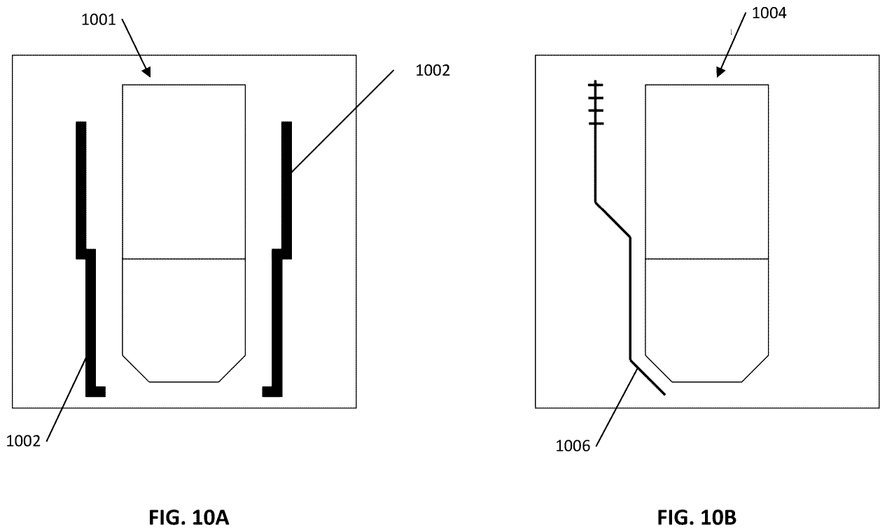

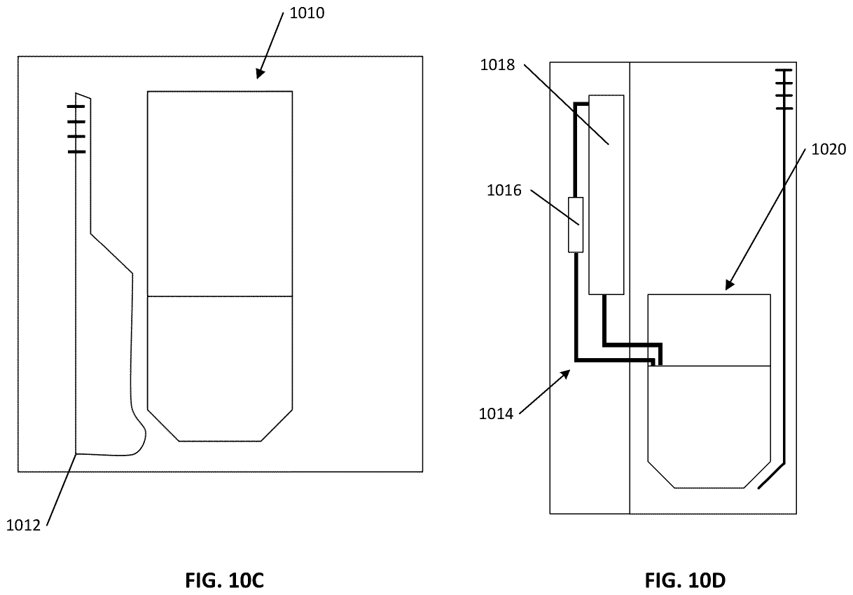

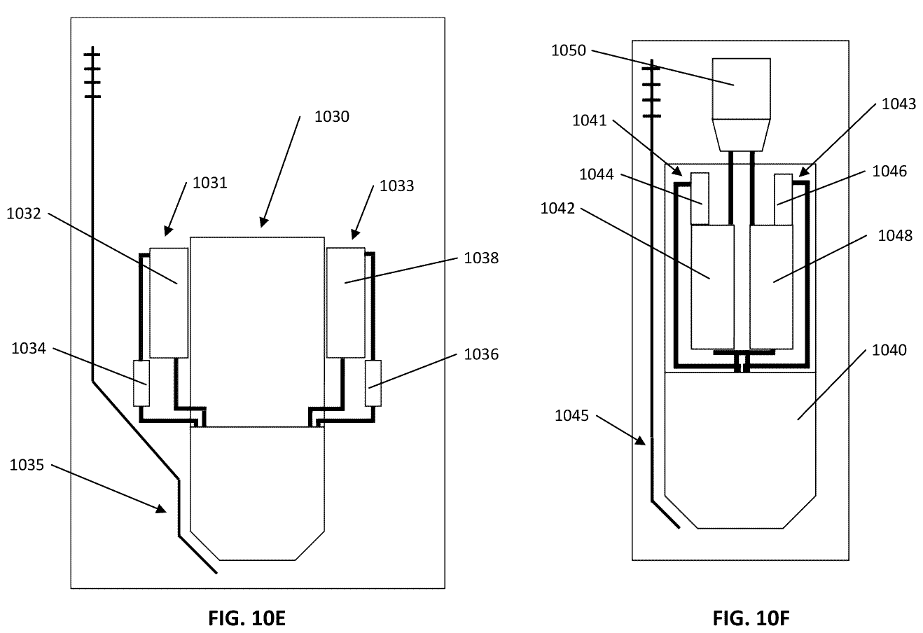

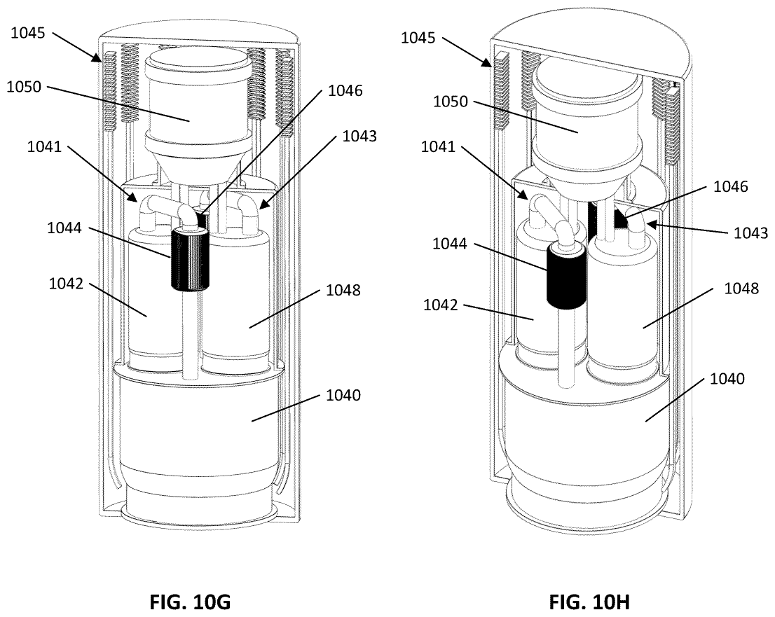

FIG. 10A-10C show schematic illustrations of example implementations of a cooling apparatus for a nuclear reactor vessel, such as is used in the power generation system of FIGS. 9A-9B. The example implementations of the cooling apparatus can include a radiator panel system (FIG. 10A), a thermosiphon system (FIG. 10B), and/or a natural circulation closed cooling loop (FIG. 10C).

Afterheat can be removed directly from the reactor vessel and coolant loop by conduction, radiation, and convection to the surrounding environment. Dedicated or multipurpose heat exchangers can also be used. In some examples, air ducts carry cool air from the surrounding environments to convectively cool the reactor system by natural circulation. The air is guided to flow along the vessels, piping, and heat exchangers to cool the components, and the air flows out of the compartment via outlets.

In some examples, cooling panels and/or cooling jackets surround the reactor system, and heat from the reactor system is transferred to the cooling panels and jackets via conduction, radiation, and convection. The cooling panels and jackets then transfer the heat to the ambient environment. The cooling panels and jackets can use coolants such as water, gases like nitrogen or carbon dioxide, liquid metals like sodium-potassium alloys, or fusible metals like sodium which are solid at normal operating conditions, and can absorb heat via latent heat of fusion.

The embodiment of FIG. 10A includes a reactor vessel 1001 and cooling panels 1002. The cooling panels 1002 are external to the reactor vessel 1001. The embodiment of FIG. 10B includes a reactor vessel 1004 and a cooling thermosiphon 1006. The cooling thermosiphon 1006 can be used for passive heat exchange, based on natural convection which circulates a fluid without the necessity of a mechanical pump. The cooling thermosiphon 1006 is external to the reactor vessel 1004. The embodiment of FIG. 10C includes reactor vessel 1010 and a cooling loop 1012. The cooling loop 1012 is external to the reactor vessel 1010, and is a closed natural convection cooling loop.

FIGS. 10D-10F show schematic illustrations of a side view of example implementations of at least a portion of a power generation system with a nuclear reactor system. For example, in contrast to the “horizontally arranged” configuration of a power generation system shown in FIGS. 9A-9B, FIGS. 10D-10F show a vertically arranged configuration of a power generation system. For example, as shown, one or more pumps and heat exchangers can be arranged vertically in relation to the reactor vessel of the nuclear reactor system.

FIG. 10D shows an example implementation in which there is a single-loop (e.g., one heat exchange loop that thermally couples the power generation system with the nuclear reactor system) arranged vertically offset in relation to the reactor vessel 1020. The heat exchange loop 1014 includes a pump 1016 and a heat exchanger 1018.

FIG. 10E shows an example implementation in which there is a dual-loop (e.g., two heat exchange loops that thermally couple the power generation system with the nuclear reactor system) arranged horizontally and vertically offset in relation to the reactor vessel 1030. A first heat exchange loop 1031 includes a pump 1034 and a heat exchanger 1032. A second heat exchange loop 1033 includes a pump 1036 and a heat exchanger 1038. The implementation of FIG. 10E also includes a thermosiphon 1035.

FIG. 10F shows an example implementation in which there is a dual-loop (e.g., two heat exchange loops that thermally couple the power generation system, shown in this figure, with the nuclear reactor system) arranged vertically, or “stacked,” above in relation to the reactor vessel 1040. FIGS. 10G-10H show a three-dimensional side view and a three-dimensional perspective view, respectively, of the nuclear reactor system of FIG. 10F.

In the embodiment of FIGS. 10F-10H, a first heat exchange loop 1041 includes a coolant pump 1044 and a heat exchanger 1042. A second heat exchange loop 1043 includes a coolant pump 1046 and a heat exchanger 1048. The embodiment of FIGS. 10F-10H also includes a thermosiphon 1045. The thermosiphon 1045 functions as a passive after heat removal system. The implementation of FIGS. 10F-10H also includes a power conversion system 1050 including power conversion turbomachinery. The power conversion system 1050 is arranged vertically above in relation to the reactor vessel 1040.

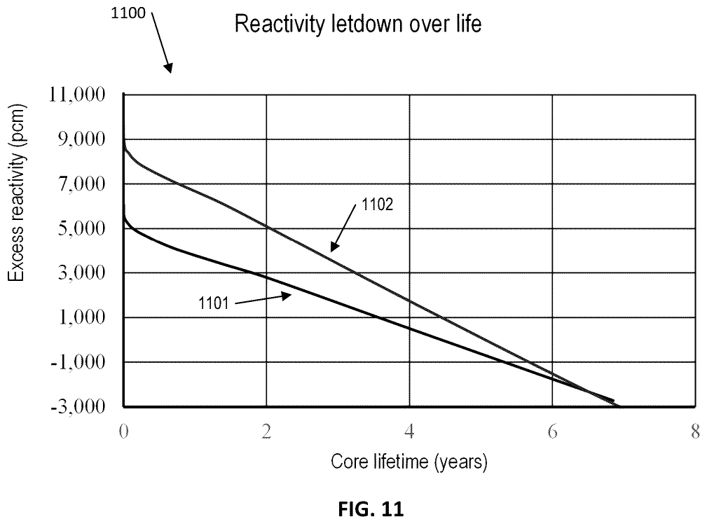

FIG. 11 shows a graph 1100 of core design performance over life for example implementations of the present disclosure. The graph 1100 shows a plot 1101 of reactivity letdown over core life for a first embodiment having a reflector (130, 330, 430, 530, 532) composed of graphite. The graph 1100 also shows a plot 1102 of reactivity letdown over core life for a second embodiment having a reflector (130, 330, 430, 530, 532) composed of beryllium. As shown in the graph 100, at beginning of core life, the first embodiment has an excess reactivity of between five thousand and seven thousand percent mille (pcm), and the second embodiment has an excess reactivity of between eight thousand and nine thousand pcm. The first embodiment and the second embodiment each have an excess reactivity that decreases to approximately −3,000 (pcm) over a time duration of between six and eight years following the beginning of core life.

In the present disclosure, an implementation showing a singular component should not be considered limiting; rather, the disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

1. A commercial nuclear fuel system, comprising:
a vessel that defines an inner volume;
a reactor core positioned within the inner volume; and
a plurality of fuel pins disposed in the reactor core, each of the plurality of fuel pins comprising at least one hydride fuel element positioned in a cladding, wherein the at least one hydride fuel element is enriched to twenty percent or less of fissile material.

2. The commercial nuclear fuel system of claim 1, wherein the at least one hydride fuel element comprises at least one of:
fissile material mixed with a metal hydride; or
fissile material that comprises a hydride.

3. The commercial nuclear fuel system of claim 1, wherein the fissile material comprises one or more of uranium-233, uranium-235, or plutonium-239.

4. The commercial nuclear fuel system of claim 1, wherein the plurality of fuel pins are positioned in a lattice within the reactor core.

5. The commercial nuclear fuel system of claim 4, wherein the lattice comprises a hexagonal lattice.

6. The commercial nuclear fuel system of claim 1, wherein the vessel comprises a first vessel that surrounds the plurality of fuel pins in the reactor core.

7. The commercial nuclear fuel system of claim 6, further comprising a second vessel that is positioned within the first vessel and surrounds the plurality of fuel pins in the reactor core.

8. The commercial nuclear fuel system of claim 6, further comprising at least one reflector that is positioned within the first vessel and surrounds the plurality of fuel pins in the reactor core.

9. The commercial nuclear fuel system of claim 8, wherein the at least one reflector comprises:
a first reflector positioned between the first vessel and the plurality of fuel pins in the reactor core; and
a second reflector positioned between the first reflector and the plurality of fuel pins in the reactor core.

10. The commercial nuclear fuel system of claim 8, further comprising a shielding assembly positioned between the first reflector and the first vessel.

11. The commercial nuclear fuel system of claim 1, wherein at least one hydride fuel element comprises a plurality of hydride fuel elements arranged in a stacked column within the cladding.

12. The commercial nuclear fuel system of claim 1, wherein each of the plurality of fuel pins further comprises a bonding layer between at least one hydride fuel element and the cladding.

13. The commercial nuclear fuel system of claim 1, wherein each of the plurality of fuel pins further comprises an upper reflector positioned within the cladding above at least one hydride fuel element.

14. The commercial nuclear fuel system of claim 1, wherein each of the plurality of fuel pins further comprises a lower reflector positioned within the cladding below at least one hydride fuel element.

15. The commercial nuclear fuel system of claim 1, wherein each of the plurality of fuel pins further comprises a plenum formed within the cladding above at least one hydride fuel element.

16. The commercial nuclear fuel system of claim 15, wherein the plenum is formed within the cladding above the upper reflector.

17. The commercial nuclear fuel system of claim 15, wherein the plurality of plenums of the plurality of fuel pins are fluidly coupled to form a flow path for a cooling fluid.

18. The commercial nuclear fuel system of claim 17, wherein the flow path is fluidly coupled to a cooling fluid inlet formed in the vessel and to a cooling fluid outlet formed in the vessel.

19. The commercial nuclear fuel system of claim 1, wherein at least one hydride fuel element is enriched to less than one of: fifteen percent of fissile material, ten percent of fissile material, or five percent of fissile material.

20. The commercial nuclear fuel system of claim 1, wherein at least one hydride fuel element is fabricated by a process in which a powder metal is hydrided and alloyed.

21. The commercial nuclear fuel system of claim 1, wherein at least one hydride fuel element is fabricated by a process in which a metal is alloyed, powdered, and hydrided.

22. The commercial nuclear fuel system of claim 1, wherein at least one hydride fuel element is fabricated by a process in which a solid metal alloy containing fuel is hydrided.

23. The commercial nuclear fuel system of claim 1, wherein hydriding occurs in a hydrogen atmosphere or in a hydrogen stream.

24. The commercial nuclear fuel system of claim 8, wherein at least one reflector is movable in a periphery of the reactor core.

25. The commercial nuclear fuel system of claim 1, further comprising at least one control rod.

26. The commercial nuclear fuel system of claim 25, wherein at least one control rod is movable in a periphery of the reactor core.

27. The commercial nuclear fuel system of claim 26, wherein an absorbing material of at least one control rod comprises at least one of B₄C, hafnium, or silver-indium-cadmium.

28. The commercial nuclear fuel system of claim 1, wherein at least one fuel pin of the plurality of fuel pins is fabricated by a process that comprises:
loading at least one hydride fuel element into the cladding;
positioning a metallic bond material in solid form below or on top of the at least one hydride fuel element in the cladding; and
sealing the at least one fuel pin.

29. The commercial nuclear fuel system of claim 28, wherein the sealing comprises welding.

30. The commercial nuclear fuel system of claim 28, wherein the metallic bond material is preloaded into the cladding below the at least one hydride fuel element or on top of the at least one hydride fuel element, or both.

31. The commercial nuclear fuel system of claim 28, wherein the process further comprises:
heating the at least one fuel pin to melt the metallic bond material to surround the at least one hydride fuel element; and
moving the heated at least one fuel pin to flow the melted metallic bond material to fully surround the at least one hydride fuel element.

32. The commercial nuclear fuel system of claim 31, wherein moving comprises at least one of shaking, tapping, or vibrating.

33. The commercial nuclear fuel system of claim 28, wherein the metallic bond material comprises a compressible thermal bond material.

34. The commercial nuclear fuel system of claim 33, wherein the compressible thermal bond material comprises porous graphite.

35. The commercial nuclear fuel system of claim 1, wherein the cladding comprises a low neutron absorbing material.

36. The commercial nuclear fuel system of claim 35, wherein the low neutron absorbing material comprises at least one of Niobium 1% Zirconium (Nb1Zr), Zirconium Carbide (ZrC), silicon carbide (SiC), Zirconium Nitride, stainless steel, nickel-based superalloys, or an isotopically enriched metallic compound.

37. The commercial nuclear fuel system of claim 1, wherein at least one hydride fuel element comprises an isotopically enriched metal to reduce neutron absorption.

38. The commercial nuclear fuel system of claim 8, wherein at least one reflector comprises at least one of a beryllium alloy, a beryllium ceramic, or graphite.

39. The commercial nuclear fuel system of claim 1, further comprising at least one refueling duct or channel.

40. The commercial nuclear fuel system of claim 1, wherein the system is configured to transport in a containerized packaging by at least one of truck, rail, barge, or air.

41-50. (canceled)
